(19) United States
(12) Patent Application Publication
(10) Pub. No.: US 2023/0332805 A1
(43) Pub. Date: Oct. 19, 2023

(54) GEOTHERMAL HEAT EXCHANGE APPARATUS

(71) Applicant: CERAPHI ENERGY LIMITED, Norfolk (GB)

(72) Inventors: Iain PITTMAN, Norfolk (GB); Karl FARROW, Norfolk (GB); Gary WILLIAMS, Norfolk (GB); Per GWALTER, Devon (GB); Martin HINDICKY, Bratislava (SK)

(21) Appl. No.: 18/027,086

(22) PCT Filed: Aug. 31, 2021
(86) PCT No.: PCT/GB2021/052245

§ 371 Date: Mar. 17, 2023

(30) Foreign Application Priority Data
Sep. 18, 2020 (GB) 2014712.0
Apr. 6, 2021 (GB) 2104838.4

(51) Int. Cl. F24T 10/17

(52) U.S. Cl. CPC F24T 10/17

(57) ABSTRACT

A heat exchange system and related method for retrofitting an existing bore with the said system, the system being adapted to be used within a bore formed within the ground, and being independent of formation fluids, the system comprising a first pipe and a second pipe together forming a fluid path, wherein substantially a lower end in use of each of the first pipe and the second pipe are in fluid communication with each other and with a sump, so that fluid can flow between the first pipe and the second pipe via the sump within the said bore, the system further comprising a pump adapted to drive heat exchange fluid through the said pipes and a heat exchange unit adapted to transfer thermal energy to or from the said heat exchange fluid.

### FIELD OF THE INVENTION

The present inventive concept relates to apparatus and methods for recovering thermal energy from underground, i.e. from the Earth’s crust. The inventive concept may be applied in a wide range of situations and locations such as new bore holes, existing thermal wells, existing fossil fuel wells and the like.

The present application claims priority from and explicitly incorporates the disclosures of the applicant’s earlier UK patent applications, namely 2014712.0 and 2104838.4.

### BACKGROUND TO THE INVENTION

Traditionally, geothermal recovery systems have used two bores which are in fluid communication below ground level, one bore being used to provide (cold) fluid flow downwards and the other bore being used to provide (hot) fluid flow upwards. One drawback of this traditional approach is the need for two bores - usually each requiring drilling. Traditional systems also require suitable permeability and often fluid in place, which also means that suitable existing fluid chemistry is needed. They may also require fracturing particularly for EGS (Enhanced Geothermal Systems).

The present inventive concept aims to provide a retrofit system to take advantage of an existing bore, thus eliminating the need to drill a new bore or bores. The system disclosed can also be used with a purpose-drilled bore.

The system provides a method for recovering thermal energy from within the Earth’s crust, from locations including drilled thermal wells, depleted or active oil/gas wells, other excavations - e.g., geothermal wells, boreholes, mines, shafts, caves and tunnels, etc.

### SUMMARY OF INVENTION

A first aspect of the present inventive concept provides a heat exchange system adapted to be used within a bore formed within the ground, and being independent of formation fluids, the system comprising a first pipe and a second pipe together forming a fluid path, wherein substantially a lower end in use of each of the first pipe and the second pipe are in fluid communication with each other and with a sump, so that fluid can flow between the first pipe and the second pipe via the sump within the said bore, the system further comprising a pump adapted to drive heat exchange fluid through the said pipes and a heat exchange unit adapted to transfer thermal energy to or from the said heat exchange fluid.

For ease of understanding of the terminology used in this application, in general the terms first pipe and second pipe refer to the order in which fluid flows in normal use of the system.

The system is designed to optimise the energy output from a single well bore and compared with prior art arrangements does not need a reservoir, movement of formation fluids, or mineral extraction.

The system allows for different media power/working fluid chemical composition (optimised for energy output) to be circulated at different rates, pressures and directions. The system allows for displacement/replacement of the medium being circulated to optimise changes in well temperature characteristics. Composition of the working fluid can be selected based on the thermal gradient expected or experienced within the bore and/or a likely bottom hole static temperature (BHST).

Circulation of heat exchange fluid will also be driven by natural convection, such as via thermosiphon and/or density change.

The first pipe and second pipe may have approximately the same diameter.

The first pipe may have a larger diameter than the second pipe. This arrangement provides for a generally increased fluid velocity within the second pipe in use.

Alternatively, the second pipe has a relatively larger diameter than that of the relatively smaller first pipe, and wherein in use the first smaller diameter pipe precedes the second larger diameter pipe in the fluid path.

The second pipe may comprise a portion of relatively small diameter tubing. This arrangement can be described as being a velocity string.

The first and second pipes may be arranged coaxially within the bore. In other words one of the pipes may be arranged within the other of the pipes. In a coaxial arrangement the outer pipe is sometimes referred to as an outer string.

The first and second pipes may be arranged side-by-side within the bore.

Preferably, the system comprises a production casing having a lower wall portion and a circumferential wall portion. The sump may further comprise a cap. The term cap is used for this purpose to describe a functional feature in that it provides an upper boundary to enable the sump to form an isolated unit with no exchange of fluid between the sump and other parts of the bore, so that the only fluid flow into and out of the sump is via the first pipe and the second pipe.

This arrangement provides for higher temperatures of fluid and for energy to disperse upwards and around the heat exchanger system. The cap can also form a pressure seal.

The cap comprises a physical barrier between the sump and the surrounding environment.

The system may further comprise a further annular region in which fluid may circulate. This annular region may be disposed within the sump and surrounded by a production casing. Within this annular region a convection centralizer may be provided. A convection centralizer provides a modification to the flow of fluid within the said annular region, similar to an eddy current.

Within the annular region, and depending on where it is arranged within the system, the fluid may be the heat exchange fluid or a different fluid. A different fluid may be a packer fluid. The said packer fluid may be brine, or other fluid which may be extant in the bore for example.

Below the production casing may be a portion of lower well construction. This may be newly constructed or part of an existing well. A lower well construction may comprise a variety of materials, based on requirements for lithology, permeability and the like.

The system may further comprise one or more circulation shoes, towards the lower end of the sump. Circulation shoes form a guide when installing a pipe into a bore or well; the shoe helps traverse the said pipe past shoulders, ledges and the like within the bore. A circulation shoe can also in use act as part of the flow path, for example to enable the fluid to turn a corner, for example when flowing downwards in the first pipe to flowing upwards in the second pipe.

A collective term which can include one or more elements arranged in a lower part of the sump, such as lower ends of one or more pipes, and further features such as pressure gauges, temperature gauges and the like is a bottom hole assembly.

The system may further comprise one or more landing nipples. A landing nipple comprises a shoulder and/or profile within a pipe or tube. A landing nipple can accommodate a flow control device, or another instrument such as a gauge. Thus a landing nipple facilitates additional functionality downhole, for example to temporarily stop flow or to record temperature, pressure or the like. Said landing nipples may be arranged within a pipe. For example a landing nipple may be located between the lower end and the upper end of the second pipe.

The system may further comprise at least one cable such as a fibre optic cable or a gauge cable. Such a cable may be attached — for example clamped — to part of an outer wall of one of the pipes, or to an inner wall portion of the said annular region. A fibre optic cable can provide distributed temperature sensing and data transfer.

The first pipe and/or the second pipe may be formed from a coiled tube. Use of coiled tube is advantageous because it can facilitate providing a heat exchange system in relatively small existing bores, enables relatively quick deployment and in due course recycling of coiled tube for subsequent heat exchange systems and the like.

The system may further comprise a process plant which the pump forms part of. The said process plant may further comprise a control unit. The said process plant may further comprise a choke valve. The said process plant may be adapted to monitor the temperature and pressure of the heat exchange fluid in the system. The said process plant may be adapted to control the said choke valve.

The bore may have one or more further branches. Such further branches may be arranged radially away from the bore at a downward angle thereto, and branch off from different points along the bore.

The design of such branches may be either radially from one depth, radially from multiple depths or as an extension to the bottom of the bore well. Each of these branches may be further branched to increase the heat exchange area yet further.

At least some of the branches may be further enhanced via stimulation techniques.

Each branch may be provided with a valve. Thus the flow of a fluid into or out of an individual branch can be controlled. Thus well can be completed using “smart” completion techniques allowing individual branches to be harvested for heat.

The system may further comprise a packer arranged within the bore and/or one or more branches. A packer is a downhole device used to isolate the annulus of a bore from the production pipe or pipes, enabling controlled flow. The packer may comprise means adapted to secure the packer against the casing or liner wall. Said means may comprise a hook wall slip arrangement. The packer may also comprise means adapted to create a reliable hydraulic seal to isolate the annulus. Said means may comprise an expandable elastomeric element.

In a second aspect of the present inventive concept, the heat exchange system further comprises means adapted for extracting resources from the ground.

The means adapted to extract resources from the ground may comprise one or more extraction pipes. The said one or more extraction pipes may not be in fluid communication with the said first and second pipes.

The heat exchange system may further be adapted to be used with a secondary bore joined with the said bore, wherein the means adapted to extract resources from the ground are arranged within the secondary bore.

The secondary bore may be arranged at an angle to the bore.

The system may comprise more than one secondary bore of the type described.

The present inventive concept also provides a method of adapting an existing bore to provide geothermal energy, the method comprising the steps of:
providing an existing bore with a first pipe and a second pipe together forming a fluid path, wherein substantially a lower end in use of each of the first pipe and the second pipe are in fluid communication with each other and with a sump, so that fluid can flow between the first pipe and the second pipe via the sump within the said bore;
providing a pump adapted to drive heat exchange fluid through the said pipes; and
providing a heat exchange unit adapted to transfer thermal energy to or from the said heat exchange fluid.

The method may further comprise steps of providing further elements as described herein.

Advantages of the present inventive concept will now be set out, along with further optional features.

The system, if drilled as a new bore/well, may have a mainly vertical bore and with as large a bore as practically achievable. In some instances, the bore may be drilled as; an inclined/directionally controlled well and targeted to intersect a permeable or fractured formation as deeply in the Earth as possible.

The invention concept provides effectively a “sealed unit” thermal exchanger which, in its various embodiments is connected via dual flow, separated, flowlines, or as a configuration of inner and outer tubulars. In each of the embodiments there is a downward flow tubular and an upward flow tubular. The upward flowline acting as a velocity string in the proprietary down hole thermal exchanger. The system minimises thermal losses on the upward flow and maximises thermal energy uptake on the downward flow and in the thermal exchange sump.

As outlined above the total flow area of the production (upward flow) tubulars and flowlines can create a velocity string thereby minimising the heat loss on the way to the surface by increasing the velocity of the medium being circulated on the upward journey.

The thermal exchanger circulation is driven by both surface pumps and density differences between the downward flow path and the upward flow path. Embodiments of the system have the design option of incorporating pumps such as jet/venturi pumps to aid in the thermal exchanger sump efficiency depending on delivery requirements. Additionally, there are options to include surface and subsurface flow enhancements. These components within the heat exchanger and associated pipework, are designed to introduce turbulence and thereby increase the heat transfer between the source and the collector medium.

The selected medium that is circulated within the thermal exchanger is kept separated from the medium surrounding it, which in turn is bounded by either a suitable tubular, a packing-medium or in situ rock formations, thus sealing the heat exchanger from extraneous ingress of liquid contaminants. Effectively it is a sealed system.

The system is designed in several embodiments to be adapted to various subsurface conditions. This in turn influences the development of an optimised system. These embodiments include but are not limited to:
Fully enclosed cemented wells preventing formation fluids from entering the wellbore. The construction and contents of the well are specifically designed for the given energy delivery requirement.
Fully enclosed wells, including uncemented wells allowing for convection of formation fluids and gases around a section of casing - the contents of the well are specifically designed for the given energy delivery requirement.

The cemented sections of the wells will use the best suited materials, blends and additives. These materials provide a permanent, verifiable barrier for zonal isolation of the rock formations that have been drilled through in the process of the well construction. In newly constructed wells or extension of existing wells cementatious materials with high thermal conductivity will be selected.

Defined sections of any of these tubulars and flowlines may be fully or partially insulated as required based on optimisation of the whole, integrated, system.

The system may further incorporate a specifically designed and engineered well head (not the subject of this patent application) at the surface of the well - which seals the well and tubulars of the thermal exchanger and allows for all tubulars and annuli of the well to be circulated in different directions.

The system can be integrated, optimised and designed in such a way that the medium in the thermal exchanger can circulate without the use of pumps thereby creating constant kinetic energy which can be used to produce further electricity as part of the combination of thermal and kinetically derived electricity production or solely as a kinetically derived electricity.

A specifically selected medium will be circulated in either a super-critical state or an otherwise heated state delivering to surface a source of usable energy. The recovered heat and energy is used for direct heat use applications, or to generate electricity with residual heat being used for a wider cascade of applications.

A power plant design can be optimised for the system as a whole and the inherent delivery requirements. Power systems incorporated in the integrated system can use the most technically suitable and available, power generation equipment or surface heat exchangers, depending on the energy supply demand. These may include: ORCs (Organic Rankine Cycle systems), thermal batteries, turbines, heat exchangers amongst other options in development.

The inventive concept provides a fully integrated system that can be delivered almost anywhere on the Earth’s surface. This can provide direct use heat for applications such as heating, cooling and industrial processes or indirectly by conversion to electricity for consumers.

It is scalable from one bore to a cluster or set of clusters, that may be comprised of hundreds or even thousands of bores. Each bore is scalable in output by targeting temperature alone. A cluster could be managed by a single or multiple control rooms and uses the latest AI technology for cluster operation optimisation.

There are many embodiments of the integrated system, all of which aim to de-risk geothermal projects and energy developments, thereby enabling these projects as commercial, renewable, environmentally friendly options.

In its principal form, no formation fluids are produced to surface, thereby there is no requirement for re-injection into a second well. If such formation, extractive, production was to be deemed a good option then this would be circulated from one well to another in the cluster and then finally into an injection well for safe disposal or recirculation use.

In its principal form, the fully enclosed, purposely designed and constructed, the system can provide an environmentally friendly renewable energy source. This has the capacity to be the mainstay of global, baseload energy production wherever it is required.

Thus, the inventive concept can provide a heat exchange system independent of formation fluids in which, in use of the system, a pump drives heat exchange fluid flow through pipes and a heat exchange unit transfers thermal energy to or from the heat exchange fluid; characterised in that the pipes comprise respectively designated first and second fluidly linked pipes of which the first such pipe has a relatively wider diameter than the second, relatively narrower diameter, one; and with the second, narrower diameter one of the thus-designated pipes preferably preceding the first, wider diameter one in the fluid flow path.

The second aspect as described above provides apparatus for thermal heat recovery from a ground source, the apparatus comprising a main bore formed within the ground, wherein the main bore has a thermal exchanger arranged within and wherein the apparatus is further adapted to be provided with means for extracting resources from the ground.

This is advantageous because in this arrangement there is likely to be less heat loss from the system because the said resources are likely to increase the temperature within the bore when the resources enter the bore - on the basis that said resources are likely to be warmer than the bore.

The apparatus may further comprise a secondary bore arranged at an angle to the main bore and branching therefrom, the apparatus characterised in that the secondary bore is adapted to be provided with means for extracting resources from the ground.

The thermal exchanger may comprise an inner tube arranged substantially concentrically within an outer tube. Alternatively the thermal exchanger may comprise a pair of separated tubulars in which fluid can flow.

The arrangement, when newly drilled can have a main bore with as large an inside diameter as practically achievable. A secondary bore can be drilled as a lateral, for example as an inclined/directionally controlled well and targeted to intersect useable subsurface resources. Upon mechanical completion a thermal exchanger can be installed within the main bore with a conventional completion assembly extracting resources from the secondary lateral bore.

In another embodiment, when drilled well can have a single main bore with as large an inside diameter as practically achievable. A section of which targets a useable subsurface resource. Upon mechanical completion a thermal exchanger can be installed within the main bore with a conventional completion assembly adjacently installed to extract resources from a targeted section of the main bore.

The inventive concept may include installation of a thermal exchanger which, is primarily made up of a configuration of inner and outer tubulars installed concentrically, or as a dual flow system with separated tubulars and heat gathering sump, the upward flowline in both cases is designed as a velocity string in what is a proprietary down hole thermal exchanger. In each of the embodiments there is a downward flow tubular and an upward flow tubular. The system minimises thermal losses on the upward flow and maximises thermal energy uptake on the downward flow and in the thermal exchange sump.

The total flow area of the production (upward flow) tubulars and flowlines are designed to create a velocity string thereby minimising the heat loss on the way to the surface by increasing the velocity of the medium being circulated on the upward journey.

The thermal exchanger circulation can be driven by both surface pumps and density differences between the downward flow path and the upward flow path.

The selected medium (selected based on thermal gradient and heat flow) that is circulated within the thermal exchanger is kept separated from the medium surrounding it, which in turn is bounded by either suitable casing a packing-medium or in situ rock formations.

The branched arrangement can be designed in several embodiments depending on the specific subsurface conditions where the development is planned and for the optimisation of the system. All of which can have a hydrocarbon production interval isolated from the lower section of the heat recovery system. The embodiments include but are not limited to:
New fully enclosed and cemented wells with no formation fluids within the heat recovery target envelope, the contents of which are specifically designed for the given energy delivery requirement.
New fully enclosed wells with an uncemented or perforated heat recovery target interval allowing for convection of formation fluids around a section of tubulars.
Repurposed fully enclosed and cemented wells with no formation fluids within the heat recovery envelope, the contents of which are specifically designed for the given energy delivery requirement.
Repurposed fully enclosed wells with an uncemented or perforated heat recovery target interval allowing for convection of formation fluids around a section of tubulars.

The branched arrangement can be put into effect with concentric/coaxial pipes or side-by-side pipes as described.

Some advantages are:
Allows the early recovery of exploration and appraisal costs. Through installation of geothermal heat recovery completion architecture energy production can begin soon after drilling operations are complete.
The wellbore architecture for eventual use in heat recovery can serve as a pilot hole providing geological control for reservoir positioning and other application during the drilling and completion phases of well construction.
Facilitates the use and transition of an experienced workforce from the oil and gas industry into the geothermal renewable space.
Extends the life of the well and provides a window for integrity monitoring.
Can produce power, heat and cooling throughout a wells’ hydrocarbon lifetime and onwards past cessation of hydrocarbon production.
Provides clean green energy usage for field development with any excess used for localised application and/or sold on.
Benefits the local community through supply of heat and power which can support other resources.
Reduces the carbon footprint of hydrocarbon production.
Provides a baseload 24/7 energy supply.

Thus the second aspect of the present inventive concept can provide apparatus for thermal heat recovery from a ground source, the apparatus comprising a main bore formed within the ground, wherein the main bore has a thermal exchanger arranged within and wherein the apparatus is adapted to be provided with means for extracting resources from the ground.

The apparatus may further comprise a secondary bore arranged at an angle to the main bore and branching therefrom, the apparatus characterised in that the secondary bore is adapted to be provided with means for extracting resources from the ground.

Advantageously, the thermal exchanger comprises an inner tube arranged substantially concentrically within an outer tube. Alternatively the thermal exchanger may comprise a pair of separated tubulars in which fluid can flow.

### DETAILED DESCRIPTION OF THE INVENTION

In these exemplary embodiments, respective features have been labelled with the same labels throughout; however the skilled reader will appreciate that features which have been labelled consistently across embodiments do not necessarily share every aspect with correspondingly labelled features in other embodiments. In other words, each embodiment should be understood to be independent from the others unless explicitly linked.

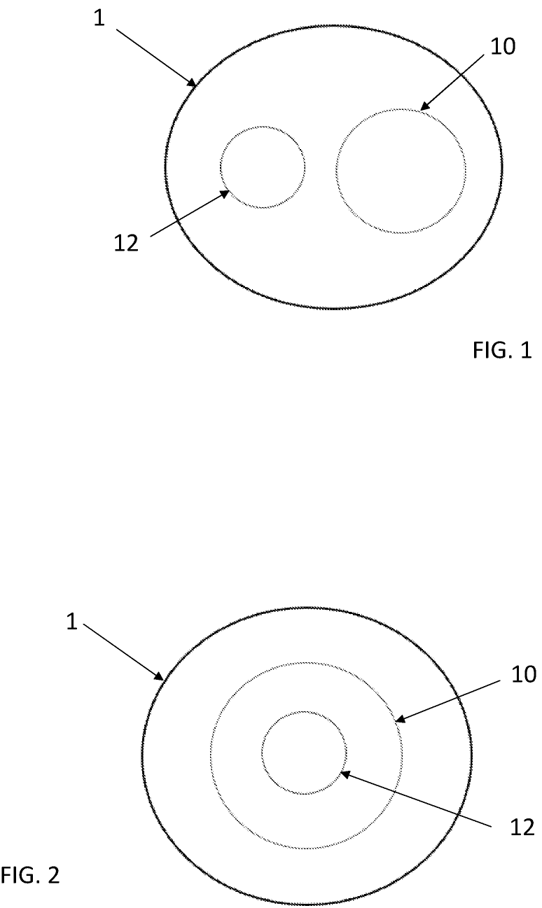

In FIG. 1, a horizontal cross-section through a main bore 1 is shown, with a first pipe 10 and second pipe 12 arranged within the bore 1. In the arrangement of FIG. 1, the first pipe 10 and second pipe 12 are arranged in parallel to one another and non-co-axially. In other words, the two pipes are arranged side by side within the bore 1 and with a gap between them. The first pipe 10 is of larger diameter than the second pipe 12. The first pipe 10 can be said to be a supply pipe and the second pipe 12 can be said to be a return pipe. In this arrangement, the second pipe 12 is also acting as a velocity string.

In FIG. 2, a horizontal cross-section through a main bore 1 is shown, with a first pipe 10 and second pipe 12 arranged within the bore 1. In the arrangement of FIG. 2, the first pipe 10 and the second pipe 12 are arranged in parallel and co-axially so that the relatively smaller diameter second pipe 12 is arranged within the relatively larger diameter first pipe 10. In this arrangement, the second pipe 12 is also acting as a velocity string.

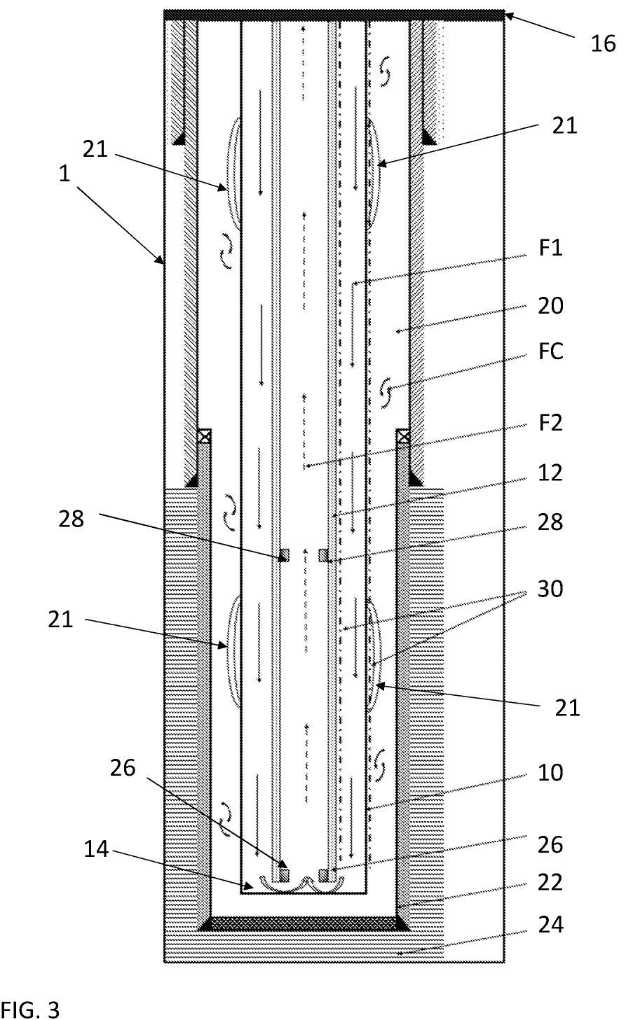

In FIG. 3, a vertical cross section of an exemplary embodiment of a system having a bore 1 in which a first pipe 10 is arranged within the bore 1, and has arranged within it approximately co-axially a second pipe 12. A sump 14 is in fluid communication with the first pipe 10 and the second pipe 12 and together the first pipe 10, sump 14 and second pipe 12 form a fluid path. A pump (not shown in FIG. 3) drives heat exchange fluid (marked with various flow arrows in FIG. 3) through the system. Circulation of heat exchange fluid will also be driven by natural convection, such as via thermosiphon and/or density change.

The first pipe 10 forms the outer boundary of the sump 14, and the sump 14 is surrounded by a further annular region 20, i.e. between the first pipe 10 and a production casing 22 which is a lining of the bore 1 (which may be newly constructed or part of an existing well). Within the annular region 20 are arranged convection centralizers 21. As indicated by convection flow arrow FC, packer fluid convection occurs within the annular region 20 region.

At the top of the bore 1 a well head acts as a cap 16.

Below the production casing 22 is a portion of lower well construction 24. This may be newly constructed or part of an existing well.

Towards the lower end of the second pipe 12 is arranged a circulation shoe 26 which forms a narrowing of the second pipe 12.

Between the lower end and the upper end of the second pipe 12 — closer to the lower end in FIG. 3 — is arranged a landing nipple 28.

Arranged vertically within the first pipe 10 and the annular region 20 are fibre optic cables 30 (indicated by dashed lines) which provide distributed temperature sensing and data transfer.

The first pipe 10 and/or the second pipe 12 may be formed from a coiled tube.

Fluid flow arrows F1 (downwards) and F2 (upwards) show the approximate fluid flow within the first pipe 10 and the second pipe 12 in use. The second pipe 12 directs fluid to a heat exchange unit (not shown in FIG. 3).

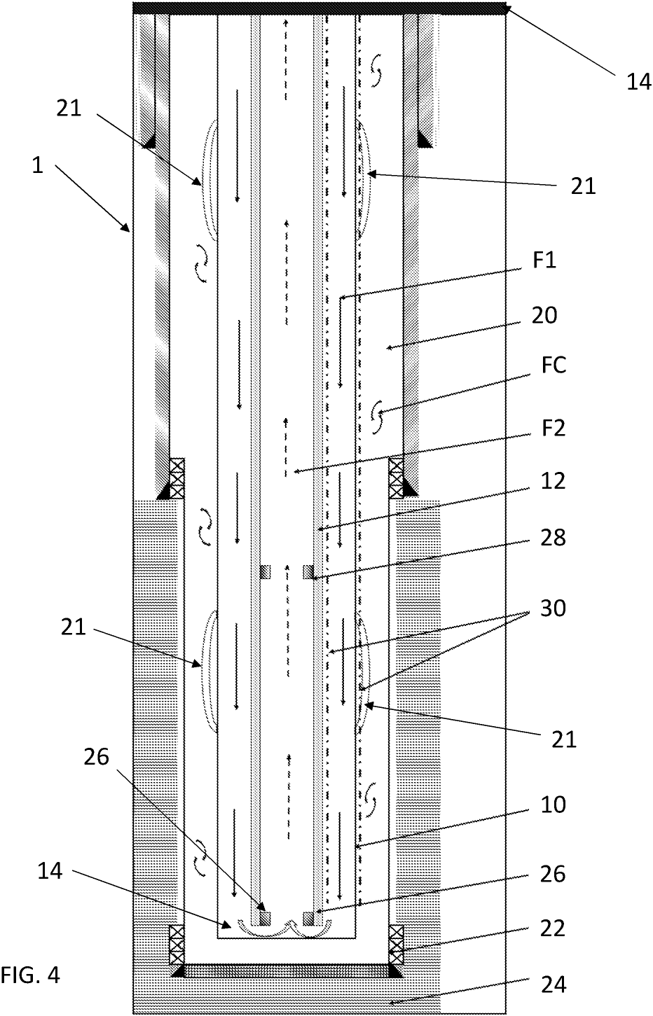

FIG. 4 shows a further exemplary embodiment, similar to that of FIG. 3. The reader will appreciate that the description, features, labels etc. of FIG. 3 apply similarly to FIG. 4.

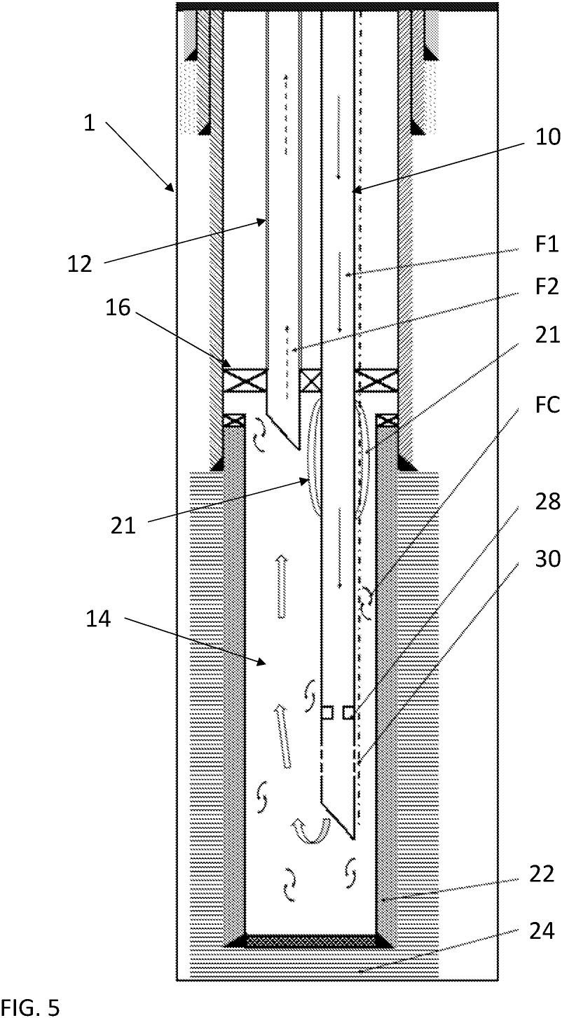

FIG. 5 shows a vertical cross section of a further exemplary embodiment. In FIG. 5, the bore 1 has arranged within it a first pipe 10 and a second pipe 12 substantially parallel to one another within the bore 1. First pipe 10 is much longer than second pipe 12. The lower ends of the first pipe 10 and second pipe 12 are each in fluid communication with a sump 14 and together the first pipe 10, sump 14 and second pipe 12 form a fluid path. A pump (not shown in FIG. 5) drives heat exchange fluid (labelled with various flow arrows in FIG. 5) through the system.

The first 10 and second 12 pipes convection centralizers 21 are arranged within the sump 14. As indicated by convection flow arrow FC, fluid convection occurs within the sump 14.

Below the production casing 22 is a portion of lower well construction 24. This may be newly constructed or part of an existing well. Forming a barrier at the upper end of the sump 14 is a packer forming a cap 16. The packer/cap 16 forms a pressure seal around the sump 14. Above the packer/cap packer fluid can circulate.

Towards a lower end and first pipe 12 is arranged a landing nipple 28.

Arranged vertically within the sump 14, attached to the outside of the first pipe 10, is a fibre optic cable 30 (indicated by a dashed line) which provides distributed temperature sensing and data transfer.

Fluid flow arrows F1 (downwards) and F2 (upwards) show the approximate fluid flow within the first pipe 10 and the second pipe 12 in use. The second pipe 12 directs fluid to a heat exchange unit (not shown in FIG. 5).

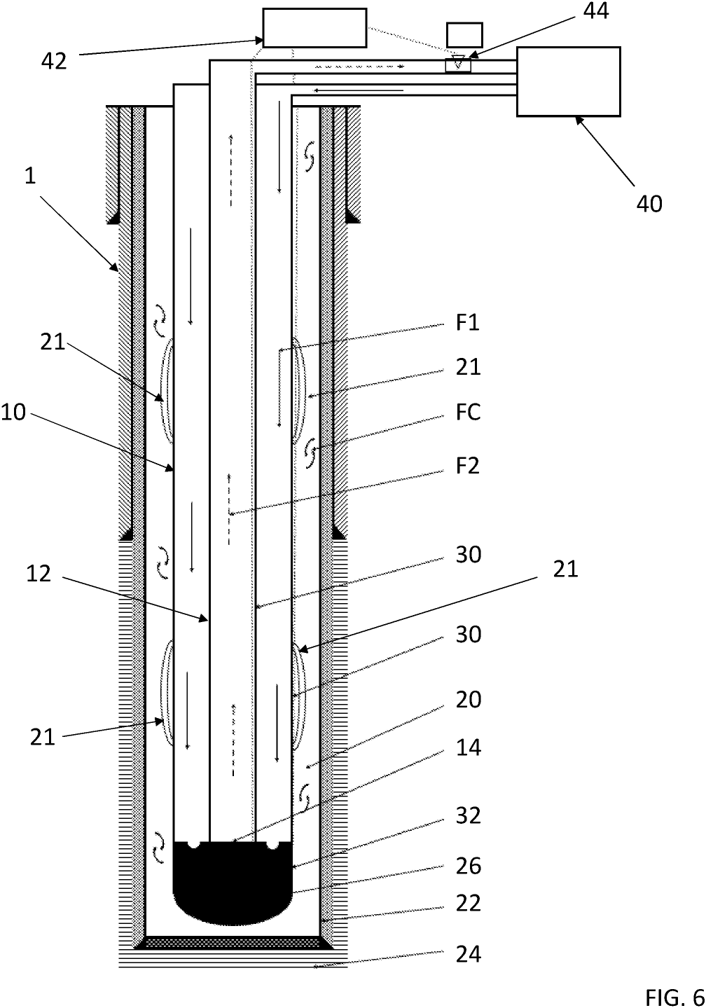

FIG. 6 shows a vertical cross section of a further exemplary embodiment. In FIG. 6, the bore 1 has arranged within it a first pipe 10 and a second pipe 12. The first pipe 10 is of larger diameter than the second pipe 12, and the second pipe 12 is arranged substantially coaxially within the first pipe 10. The lower ends of the first pipe 10 and the second pipe 12 are each at their lower ends in fluid communication with a sump 14. Together, the first pipe 10, second pipe 12 and sump 14 form a fluid path. A pump within a process plant 40 which is in fluid communication with the first pipe 10 drives heat exchange fluid (labelled with various flow arrows in FIG. 6) through the system.

The process plant 40 is adapted to monitor the temperature and pressure of the heat exchange fluid in the system, and sends information to a control unit 42 which is in turn adapted to control a choke valve 44. Thus the process plant 40 and the choke valve 44 act as an indirect cap, controlling the pressure of fluid within the system.

The first pipe 10 is surrounded by a further annular region 20, the sump 14 a production casing 22 which is a lining of the bore 1 (which may be newly constructed or part of an existing well). As indicated by flow arrow FC, fluid convection occurs within the annular region 20 region of the bore 1.

Within the annular region, convection centralizers 21 are arranged.

Below the production casing 22 is a portion of lower well construction 24. This may be newly constructed or part of an existing well.

Arranged vertically within the annular 20 region and within the second pipe 12, are fibre optic cables 30 (indicated by dashed lines) which provide distributed temperature sensing and data transfer.

Around the sump 14 is arranged a circulation shoe 26. The sump 14 is enveloped by a heat exchanger outer string 32. The lower part of the sump 14, within the circulation shoe 26 — which can also be referred to as a bottom hole assembly — can be provided with other devices.

The first pipe 10 and/or the second pipe 12 may be formed from a coiled tube.

Fluid flow arrows F1 (downwards) and F2 (upwards) show the approximate fluid flow within the first pipe 10 and the second pipe 12 in use. The second pipe 12 directs fluid to a heat exchange unit within the process plant 40.

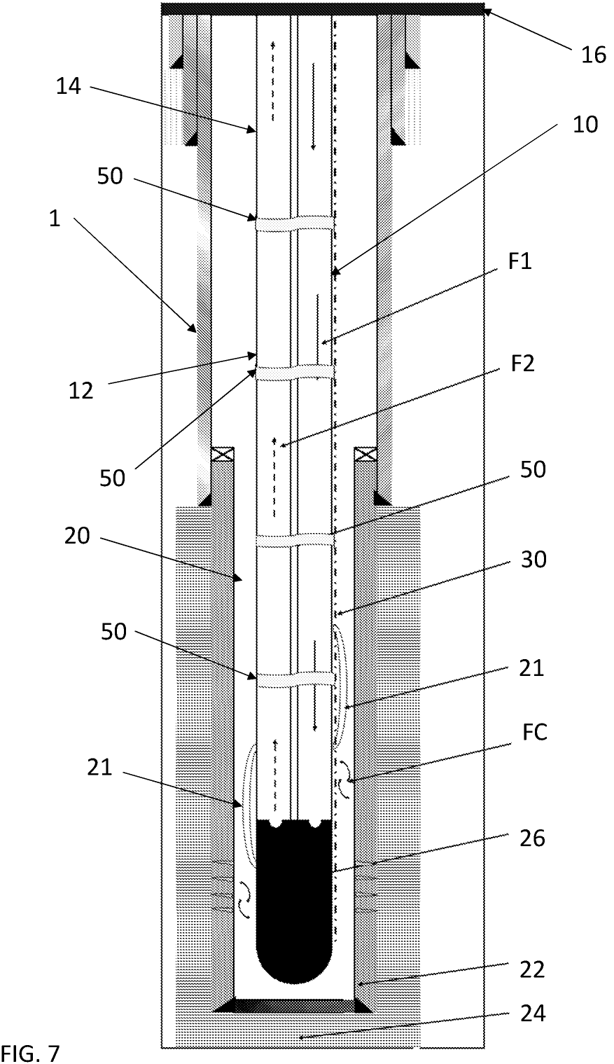

FIG. 7 shows a vertical cross section of a further exemplary embodiment. In FIG. 7 the first pipe 10 and the second pipe 12 are arranged in parallel and side by side to one another and are approximately the same length within a sump 14. The lower ends of the first 10 and second 12 pipes are disposed within a circulation shoe 26 to form a bottom hole assembly. Sump 14 has a similar circulation shoe 26 arrangement to that of FIG. 6, and is enveloped by a heat exchanger. The circulation shoe 26 can also comprise further devices (not labelled).

The embodiment of FIG. 7 also has an annular region 20 with fluid convection indicated by arrow FC. Fibre optic cable 30 is arranged within the annular region 20, externally on the pipes 10, 12. Convection centralizers 21 are arranged within the annular region 20 attached to the pipes 10, 12 respectively.

At the top of the bore 1 a well head acts as a cap 16.

The first 10 and second 12 pipes are constructed from coil tubing, and the pipes are clamped in position by coil tubing pipe clamps 50.

Within the bore 1 is a production casing 22 which forms a lining of the bore 1 (which may be newly constructed or part of an existing well); below the production casing 22 is a portion of lower well construction 24 which may be newly constructed or part of an existing well.

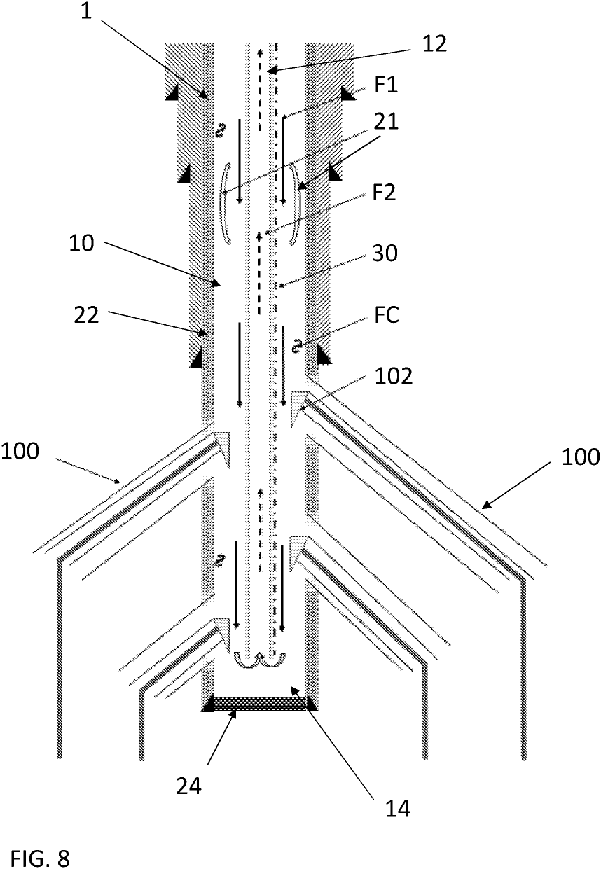

FIG. 8 shows a vertical cross section of a further exemplary embodiment. In the arrangement of FIG. 8, the bore 1 has several further branches 100 (not all labelled to aid clarity). In this embodiment, the further branches are arranged radially away from the bore 1 at a downward angle thereto, and branch off from different points along the bore 1.

Within the bore 1 is arranged a first pipe 10 and a second pipe 12, both in fluid communication with a sump 14 to form a fluid path from the first pipe 10 to the second pipe 12. In this embodiment the second pipe 12 is arranged within and substantially coaxially with the first pipe 12.

The first pipe 10 is surrounded by a further region which acts as a convective annulus . Within the sump 14 are convection centralizers 21. The apparatus also has a production casing 22 which is a lining of the bore 1 (which may be newly constructed or part of an existing well). As indicated by flow arrow FC, fluid convection occurs within the sump 14 and also around the body of the heat exchanger in the bore 1 and in the radial branches.

Arranged vertically within the first pipe 10, is a fibre optic cable 30 (indicated by a dashed line) which provides distributed temperature sensing. Additional fibre optic cable can be connected to an outer pipe within each additional branch (lateral).

At each branch between the bore 1 and each further branch 100 is a valve 102 (only one is labelled in FIG. 8 to aid clarity). These valves allow switching between each branch to allow combined circulation from all branches into the main heat exchanger assembly of pipes 10 and 12 but also allows for selected circulation to the heat exchanger by one or more of the branches 100.

Below the production casing 22 is a portion of lower well construction 24. This may be newly constructed or part of an existing well.

Fluid flow arrows F1 (downwards) and F2 (upwards) show the approximate fluid flow within the first pipe 10 and the second pipe 12 in use. The second pipe 12 directs fluid to a heat exchange unit (not shown in FIG. 8).

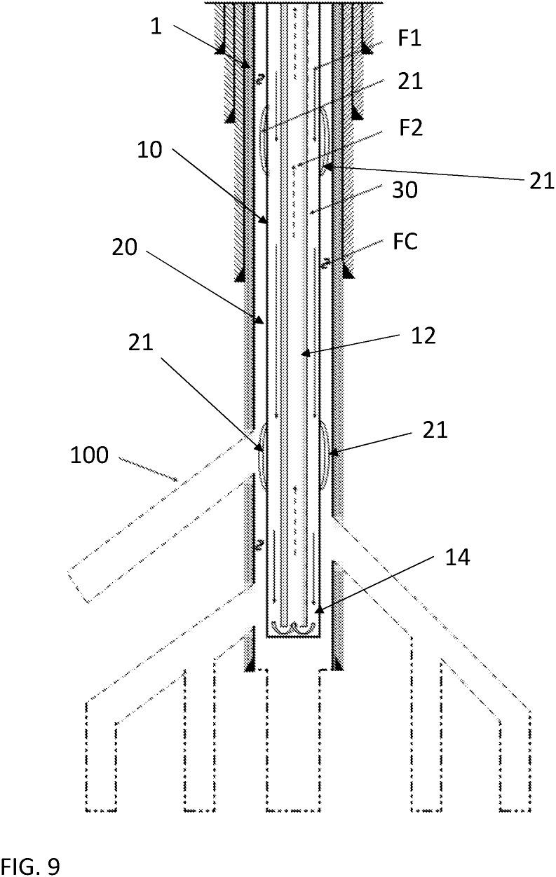

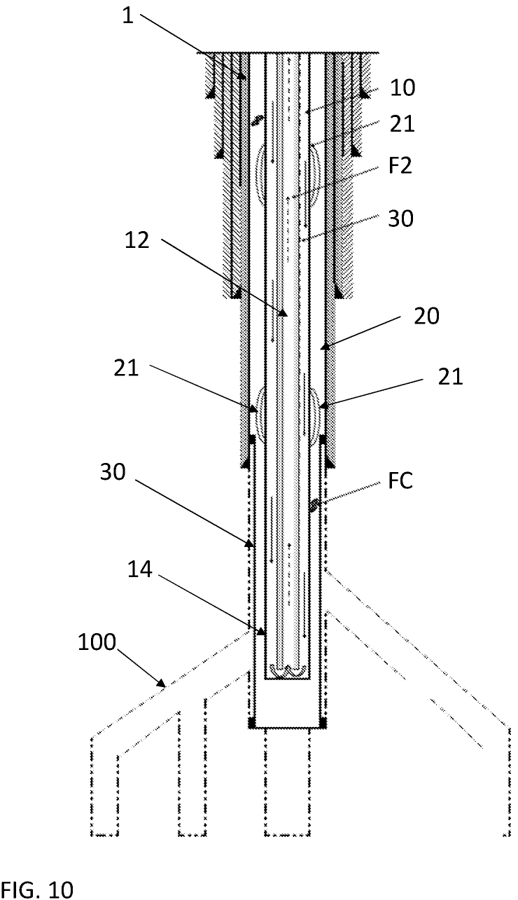

FIG. 9 shows a vertical cross section of a further exemplary embodiment. In the arrangement of FIG. 9, the bore 1 has several further branches 100 (not all labelled for clarity). In this embodiment, the further branches are arranged radially away from the bore 1 at a downward angle thereto, and branch off from different points along the bore 1.

Within the bore 1 is arranged a first pipe 10 and a second pipe 12, both in fluid communication with a sump 14 to form a fluid path from the first pipe 10 to the second pipe 12. In this embodiment the second pipe 12 is arranged within and substantially coaxially with the first pipe 10.

The first pipe 10 is surrounded by a further annular region 20 which acts as a convective annulus enhanced by convection centralizers 21 between the first pipe 10 and a production casing 22 which is a lining of the bore 1 (which may be newly constructed or part of an existing well). As indicated by flow arrow FC, fluid convection occurs within the convection centralizer 20 region of the bore 1.

Arranged vertically within the annular region 20 and within the second pipe 12, is a fibre optic cable 30 (indicated by a dashed line) which provides distributed temperature sensing. Additional fibre optic cable can be connected to the outer pipe within each additional branch 100 (lateral).

Each lateral branch 100 acts as a heat source/heat sink allowing conduction and convection of heat to the bore 1.

FIG. 10 shows a vertical cross section of a further exemplary embodiment. In the arrangement of FIG. 10, the bore 1 has several further branches 100. In this embodiment, the further branches are arranged radially away from the bore 1 at a downward angle thereto, and branch off from different points along the bore 1. The branches are extending radially behind the lower production casing.

Within the bore 1 is arranged a first pipe 10 and a second pipe 12, both in fluid communication with a sump 14 to form a fluid path from the first pipe 10 to the second pipe 12. In this embodiment the second pipe 12 is arranged within and substantially coaxially with the first pipe 12.

The first pipe 10 is surrounded by a further annular region 20 which acts as a convective annulus enhanced by a convection centralizers 21 arranged within. The annular region 20 is between the first pipe 10 and a production casing 22 which is a lining of the bore 1 (which may be newly constructed or part of an existing well). As indicated by flow arrow FC, fluid convection occurs within the annular region 20 of the bore 1.

Arranged vertically within the annular region 20 and within the second pipe 12, is a fibre optic cable 30 (indicated by a dashed line) which provides distributed temperature sensing. Additional fibre optic cables will be connected to the outer pipe within the each additional branch 100 (lateral).

Each branch 100 acts as a heat source/heat sink allowing conduction and convection of heat to the main bore 1.

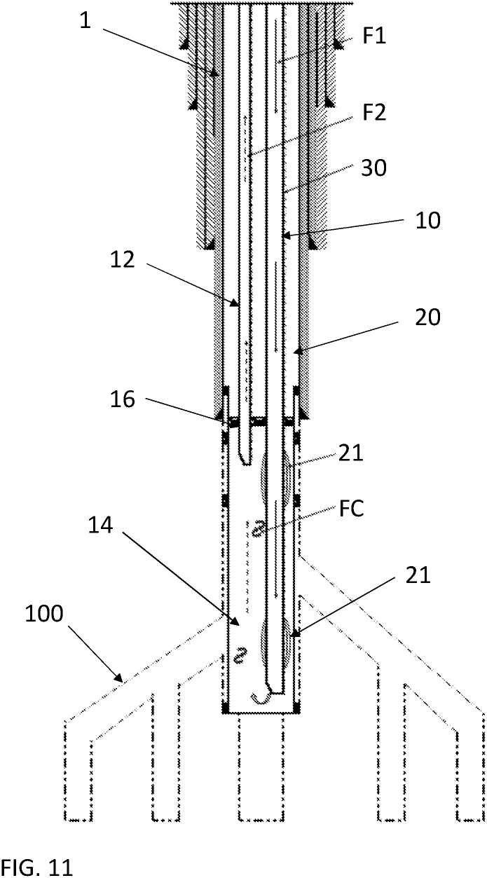

FIG. 11 shows a vertical cross section of a further exemplary embodiment. In the arrangement of FIG. 11, the bore 1 has several further branches 100. In this embodiment, the further branches are arranged radially away from the bore 1 at a downward angle thereto, and branch off from different points along the bore 1.

Within the bore 1 is arranged a first pipe 10 and a second pipe 12, both in fluid communication with a sump 14 to form a fluid path from the first pipe 10 to the second pipe 12. In this embodiment the firs pipe 10 and second pipe 12 are arranged side by side approximately in parallel with one another.

A packer acts as a cap 16 to isolate the sump 14 from the region above the sump 14 within the bore 1. Above the cap 16 is an annular region 20.

Within the sump 14 are arranged convection centralizers 21 (not all labelled for clarity).

As indicated by flow arrow FC, fluid convection occurs within the sump 14.

Arranged vertically along the outside of the first pipe 10, is a fibre optic cable 30 (indicated by a dashed line) which provides distributed temperature sensing and data transfer. Additional fibre optic cable an be connected to an outer pipe within the each additional branch 100 (lateral).

Each lateral branch 100 acts as a heat source/heat sink allowing conduction and convection of heat to the main bore.

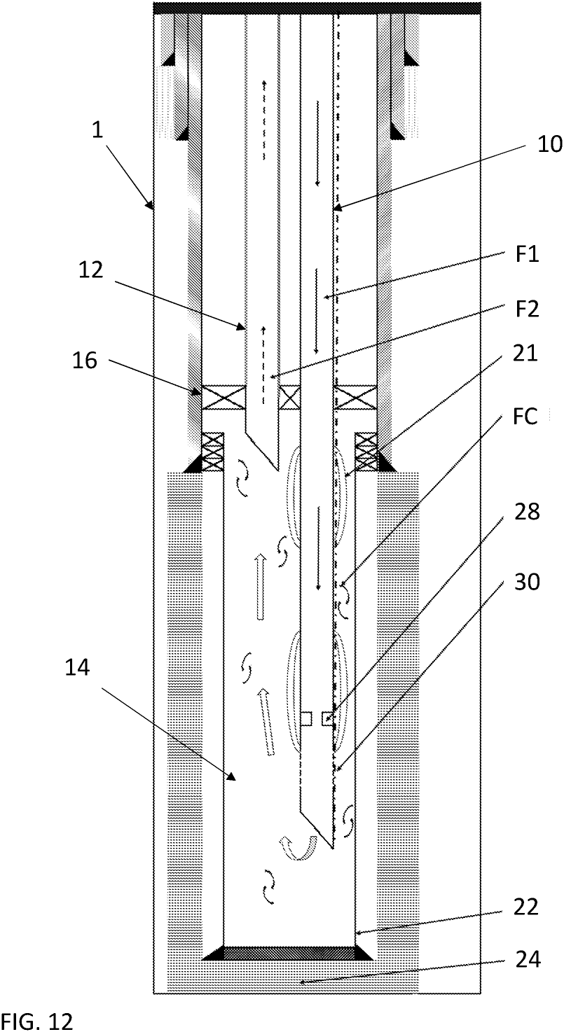

FIG. 12 shows a vertical cross section of a further exemplary embodiment. In FIG. 12, the bore 1 has arranged within it a first pipe 10 and a second pipe 12 substantially parallel to one another within the bore 1. First pipe 10 is much longer than second pipe 12. The lower ends of the first pipe 10 and second pipe 12 are each in fluid communication with a sump 14 and together the first pipe 10, sump 14 and second pipe 12 form a fluid path. A pump (not shown in FIG. 12) drives heat exchange fluid (marked with various flow arrows in FIG. 12) through the system. The sump 14 is surrounded by a production casing 22 which is a lining of the bore 1 (which may be newly constructed or part of an existing well). This may or may not be cemented in place depending on the rock in which it is sited in order to maximise heat transfer from the rock.

Below the production casing 22 is a portion of lower well construction 24. This may be newly constructed or part of an existing well. A packer acts as a cap 16 to isolate the sump 14 from packer fluid above the cap 16. The cap 16 also forms a pressure seal around the sump 14.

Within the sump 14 there are convection centralizers 21 (not all labelled for clarity).

Towards a lower end and first pipe 12 is arranged a landing nipple 28.

Arranged vertically on the outside of the first pipe 10, is a fibre optic cable 30 (indicated by a dashed line) which provides distributed temperature sensing.

The first pipe 10 and/or the second pipe 12 may be formed from a coiled tube.

Fluid flow arrows F1 (downwards) and F2 (upwards) show the approximate fluid flow within the first pipe 10 and the second pipe 12 in use. The second pipe 12 directs fluid to a heat exchange unit (not shown in FIG. 9).

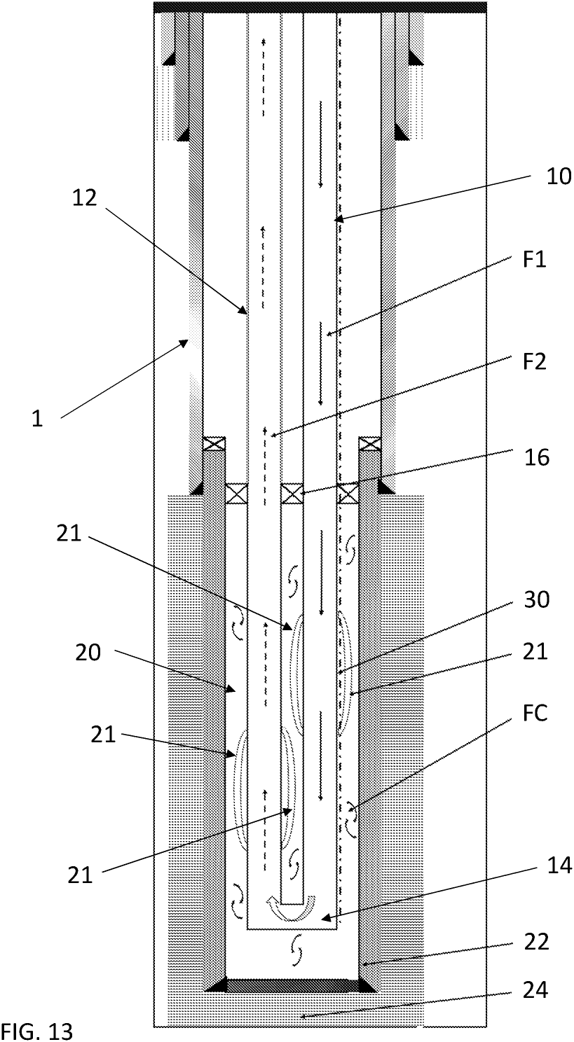

FIG. 13 shows a vertical cross section of a further exemplary embodiment. In FIG. 13, the bore 1 has a first pipe 10 and a second pipe 12 arranged in parallel with one another approximately vertically within the bore 1. A sump 14 is in fluid communication with the first pipe 10 and the second pipe 12 and together the first pipe 10, sump 14 and second pipe 12 form a fluid path. A pump (not shown in FIG. 10) drives heat exchange fluid (marked with various flow arrows in FIG. 10) through the system.

The first 10 and second 12 pipes are surrounded within the sump 14 by a further annular region 20 between the pipes (10, 12) and a production casing 22 which is a lining of the bore 1 (which may be newly constructed or part of an existing well). As indicated by convection flow arrow FC, fluid convection occurs within the sump 14. Within the annular region 20 are arranged convection centralizers 21.

Below the production casing 22 is a portion of lower well construction 24. This may be newly constructed or part of an existing well. A packer acts as a cap 16 to isolate the sump 14 from packer fluid above the cap 16.. The cap 16 also forms a pressure seal around the sump 14.

Arranged vertically on the outer part of the first pipe 10 is a fibre optic cable 30 (indicated by a dashed line) which provides distributed temperature sensing and data transfer.

The first pipe 10 and/or the second pipe 12 may be formed from a coiled tube.

Fluid flow arrows F1 (downwards) and F2 (upwards) show the approximate fluid flow within the first pipe 10 and the second pipe 12 in use. The second pipe 12 directs fluid to a heat exchange unit (not shown in FIG. 13).

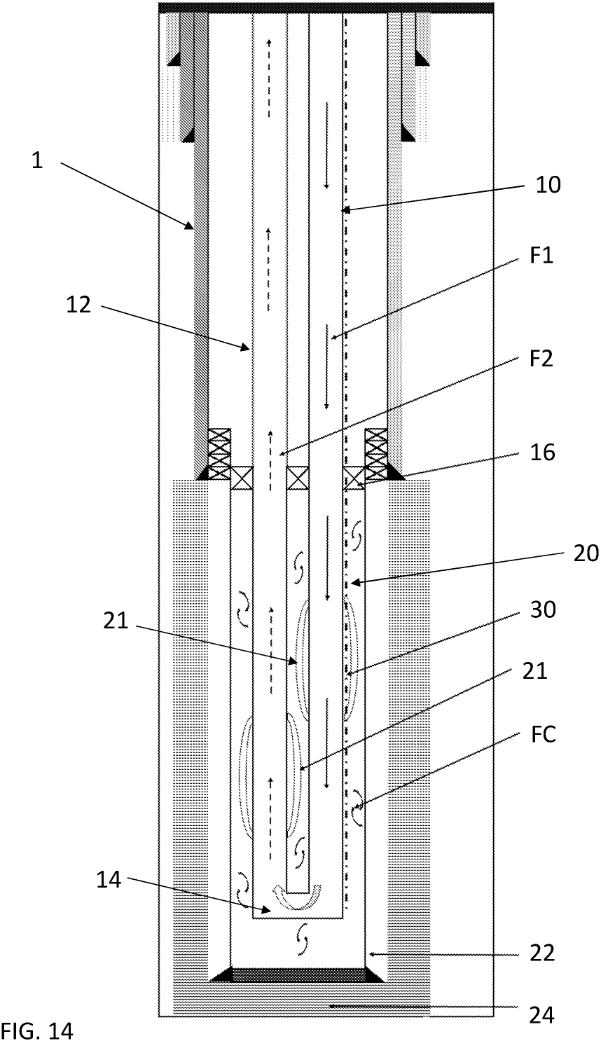

FIG. 14 shows a vertical cross section of a further exemplary embodiment. In FIG. 14, the bore 1 has a first pipe 10 and a second pipe 12 arranged in parallel with one another approximately vertically within the bore 1. A sump 14 is in fluid communication with the first pipe 10 and the second pipe 12 and together the first pipe 10, sump 14 and second pipe 12 form a fluid path. A pump (not shown in FIG. 14) drives heat exchange fluid (marked with various flow arrows in FIG. 14) through the system.

The sump 14 is isolated at the top by a packer which forms a cap 16. The cap 16 also forms a pressure seal around the sump 14.

The first 10 and second 12 pipes are surrounded within the sump 14 by a further annular region 20 and subsequently by a production casing 22 which is a lining of the bore 1 (which may be newly constructed or part of an existing well). As indicated by convection flow arrow FC, fluid convection occurs within the annular region 20 region. Within the annular region 20 are arranged convection centralizers 21 (not all labelled to aid clarity).

Below the production casing 22 is a portion of lower well construction 24. This may be newly constructed or part of an existing well.

Arranged vertically on the outer part of the first pipe 10 is a fibre optic cable 30 (indicated by a dashed line) which provides distributed temperature sensing and data transfer.

The first pipe 10 and/or the second pipe 12 may be formed from a coiled tube.

Fluid flow arrows F1 (downwards) and F2 (upwards) show the approximate fluid flow within the first pipe 10 and the second pipe 12 in use. The second pipe 12 directs fluid to a heat exchange unit (not shown in FIG. 14).

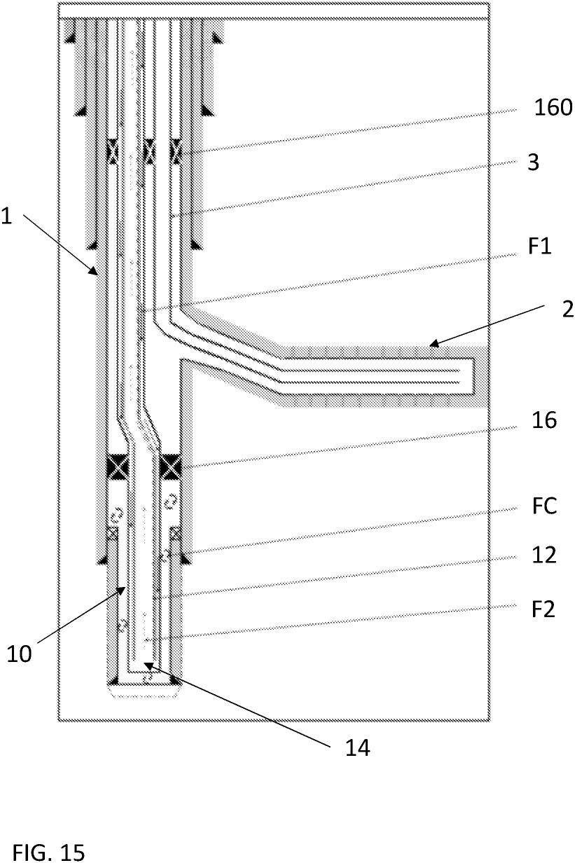

FIG. 15 shows an exemplary embodiment of the system, in vertical cross section. This embodiment has a bore 1 within which are arranged a first pipe 10 and a second pipe 12 arranged approximately coaxially within the bore 1 — each of the first 10 and second 12 pipes being in fluid communication via a sump 14. A packer / cap 16 provides a pressure seal and isolation for that part of the system.

The embodiment of FIG. 15 also has a secondary bore 2 which branches off the bore 1 along its length; in this embodiment the branch of the secondary bore 2 from the bore 1 is above the region occupied by the sump 14 and cap 16. Within the secondary bore 2 a third pipe 3 is arranged. The third pipe 3 is adapted to extract mineral resources from underground regions connected to secondary bore 2.

An upper cap 160 provides a pressure seal and isolation for that part of the system including the secondary bore 2.

Fluid flow arrows F1 (downwards) and F2 (upwards) show the approximate fluid flow within the first pipe 10 and the second pipe 12 in use. Fluid arrows FC also show convection flow within the sump 14.

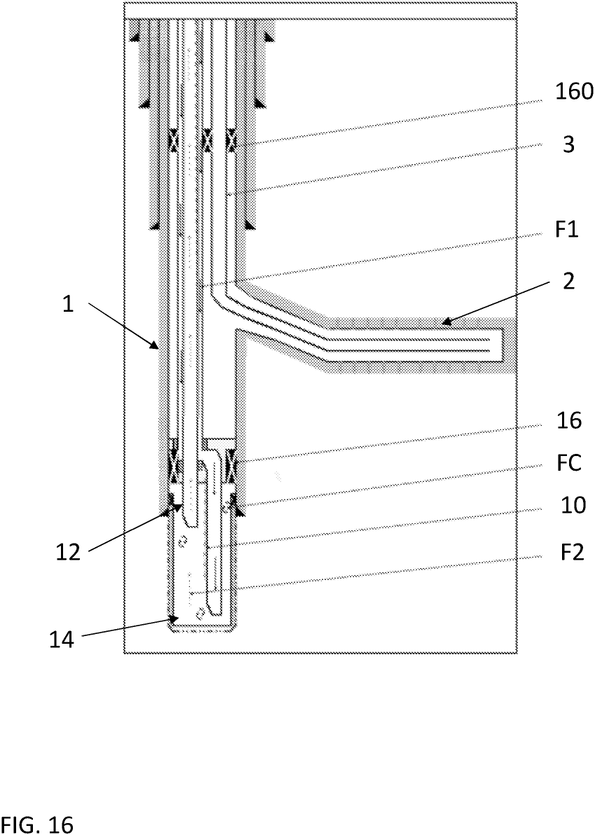

FIG. 16 shows an exemplary embodiment of the system, in vertical cross section. This embodiment has a bore 1 within which are arranged a first pipe 10 and a second pipe 12 arranged coaxially within one part of the bore 1 and side-by-side in a lower part of the bore 1. The lower ends of the first pipe 10 and the second pipe 12 are arranged in fluid communication with a sump 14. Packer / cap 16 forms a pressure seal and isolation for that part of the system in the sump 14 region.

The embodiment of FIG. 16 also has a secondary bore 2 which branches off the bore 1 along its length; in this embodiment the branch of the secondary bore 2 from the bore 1 is above the isolated region occupied by the sump 14 and cap 16. Within the secondary bore 2 a third pipe 3 is arranged. The third pipe 3 is adapted to extract mineral resources from underground regions connected to secondary bore 2.

An upper cap 160 provides a pressure seal for that part of the system including the secondary bore 2.

Fluid flow arrows F1 (downwards) and F2 (upwards) show the approximate fluid flow within the first pipe 10 and the second pipe 12 in use. Fluid arrows FC also show convection flow within the sump 14.

1-15. (canceled)

16. A heat exchange system for geothermal heat extraction adapted to be used within a bore formed within the ground, and being independent of formation fluids, the system comprising a first pipe and a second pipe together forming a fluid path, wherein substantially a lower end in use of each of the first pipe and the second pipe are in fluid communication with each other and with a sump, so that fluid can flow between the first pipe and the second pipe via the sump within the said bore, the system further comprising a pump adapted to drive heat exchange fluid through the said pipes and a heat exchange unit adapted to transfer thermal energy to or from the said heat exchange fluid, and wherein the system further comprises an annular region of the said fluid path in which fluid may circulate, within which annular region is provided a convection centralizer.

17. A heat exchange system according to claim 16, wherein the system further comprises a production casing having a lower wall portion and a circumferential wall portion.

18. A heat exchange system according to claim 16, further comprises a cap.

19. A heat exchange system according to claim 16, further comprising one or more circulation shoes.

20. A heat exchange system according to claim 16, further comprising one or more landing nipples.

21. A heat exchange system according to claim 16, further comprising at least one cable.

22. A heat exchange system according to claim 16, wherein one or other of the first and/or second pipe are formed from a coiled tube.

23. A heat exchange system according to claim 16, wherein the pump forms part of a process plant.

24. A heat exchange system, wherein the bore has one or more further branches.

25. A heat exchange system according to 16, further comprising means adapted for extracting resources from the ground.

26. A heat exchange system according to claim 25, wherein the means adapted to extract resources from the ground comprises one or more extraction pipes.

27. A heat exchange system according to claim 26, wherein the said one or more extraction pipes are not in fluid communication with the said first and second pipes.

28. A heat exchange system according to any of claims 25, further adapted to be used with a secondary bore joined with the said bore, wherein the means adapted to extract resources from the ground are arranged within the secondary bore.

29. A method of adapting an existing bore to provide geothermal energy heat extraction, the method comprising the steps of:
providing an existing bore with a first pipe and a second pipe together forming a fluid path, wherein substantially a lower end in use of each of the first pipe and the second pipe are in fluid communication with each other and with a sump, so that fluid can flow between the first pipe and the second pipe via the sump within the said bore, wherein an annular region is formed in which fluid may circulate, within which annular region of the said fluid path a convection centralizer is provided;
providing a pump adapted to drive heat exchange fluid through the said pipes; and
providing a heat exchange unit adapted to transfer thermal energy to or from the said heat exchange fluid.
